(19) United States
(12) Patent Application Publication
(10) Pub. No.: US 2020/0357279 A1
(43) Pub. Date: Nov. 12, 2020

(54) SYSTEM AND METHOD OF ADVANCED TRAFFIC MANAGEMENT

(71) Applicants: Jaime Rodriguez, Danville, CA (US); Thai Nguyen, San Jose, CA (US)

(72) Inventors: Jaime Rodriguez, Danville, CA (US); Thai Nguyen, San Jose, CA (US)

(21) Appl. No.: 16/405,119

(22) Filed: May 7, 2019

(51) Int. Cl. G08G 1/097; G08G 1/07; G08G 1/095; G08G 1/005

(52) U.S. Cl. CPC G08G 1/097; G08G 1/005; G08G 1/095; G08G 1/07

(57) ABSTRACT

A method of facilitating advanced traffic management is provided. The method comprises a panel installed in a traffic signal cabinet accessing a traffic signal controller device in the cabinet and the panel scanning data gathered by the controller, the data comprising detection inputs and alarms processed by the controller. The method also comprises the panel digitizing the scanned data for wireless transmission and the panel transmitting the digitized data to a cloud-based platform for analysis. The data gathered by the controller comprises active status data of traffic signals including data associated with vehicle detectors, pedestrian detectors, and associated equipment. Active status data of traffic signals comprises at least one of red, green, and yellow light, walk, and don't walk. Detection inputs comprise at least one of inductive loops and pedestrian push buttons. Analysis by the platform comprises at least determinations of malfunctions of equipment associated with the controller.

### FIELD OF THE INVENTION

The present disclosure is in the field of traffic management. More particularly, the present disclosure provides systems and methods of reading traffic signals and other highway traffic data from traffic signal cabinets and controllers and detecting and reporting potential problems based on analysis of the data and other factors.

### BACKGROUND

Vehicle traffic volume and bicycle-pedestrian safety are growing problems in the U.S. and elsewhere as urbanization continues, population increases, and vehicle ownership expands. Traffic on roads consists of pedestrians, bicyclists, micro-mobility vehicles, vehicles, streetcars, buses rail, and other conveyances, either singly or together, while using the public way for purposes of travel. Traffic laws govern traffic and regulate vehicles, while rules of the road are both the laws and the informal rules that may have developed over time to facilitate the orderly and timely flow of traffic. Organized traffic generally has well-established priorities, lanes, right-of-way, and traffic control at intersections.

Traffic is formally organized in many jurisdictions, with marked lanes, junctions, intersections, interchanges, traffic signals, and signs. Traffic is often classified by type: heavy motor vehicle (e.g., car, truck), other micro-mobility vehicle (e.g., scooter, moped, bicycle), pedestrian, and autonomous vehicles. Different classes may share speed limits and easement or may be segregated. Some jurisdictions may have very detailed and complex rules of the road while others rely more on drivers' common sense and willingness to cooperate.

Organization typically produces a better combination of travel safety and efficiency. Events which disrupt the flow and may cause traffic to degenerate into disorganization include road construction, collisions, and debris in the roadway. On particularly busy roads, a minor disruption may persist in a phenomenon known as traffic waves. A complete breakdown of organization may result in traffic congestion and gridlock.

Crosswalks and other pedestrian crossings are common in populated areas and may indicate that pedestrians have priority over vehicular traffic. In most modern cities, the traffic signal is used to establish the right of way at intersections with other streets or facilities. Its primary purpose is to give each roadway approach a duration of time in which its traffic or users may travel across or through the intersection in an organized way. The intervals of time assigned for each road may be adjusted to account for factors such as differences in volume of traffic, the needs of pedestrians, or other traffic signals. Pedestrian crossings may be located near other traffic control devices; if they are not also regulated in some way, vehicles must give priority to them when in use.

### BRIEF DESCRIPTION OF THE FIGURES

FIG. 1 block diagram of system of advanced traffic management according to an embodiment of the present disclosure.

FIG. 2 is a diagram of components and process flows of systems and methods of advanced traffic management system according to an embodiment of the present disclosure with field inputs from vehicle detection and pedestrian detection systems entering into a typical traffic signal cabinet.

FIG. 3 is a diagram of components and process flows of systems and methods of advanced traffic management system according to an embodiment of the present disclosure with field outputs leaving a traffic signal cabinet to traffic signal and pedestrian display equipment.

FIG. 4 is a diagram of components and process flows of systems and methods of advanced traffic management system according to an embodiment of the present disclosure with the vehicle detection and pedestrian detection and field outputs being inputted into a new traffic signal panel for data processing.

FIG. 5 is a diagram of components and process flows of systems and methods of advanced traffic management system according to an embodiment of the present disclosure with data from the traffic signal panel being digitized and transmitted to the Internet to a cloud platform.

FIG. 6 is a diagram of components and process flows of systems and methods of advanced traffic management system according to an embodiment of the present disclosure with additional cloud-based systems and devices transmitting data to the cloud platform directly connected to a typical traffic signal cabinet over wired or wireless communications to the traffic signal panel.

FIG. 7 is a diagram of components and process flows of systems and methods of advanced traffic management system according to an embodiment of the present disclosure with traffic detection received from the cloud platform through the traffic signal panel and back into the traffic signal cabinet for processing by existing traffic signal control equipment.

FIG. 8 is a diagram of components and process flows of systems and methods of advanced traffic management system according to an embodiment of the present disclosure.

### DETAILED DESCRIPTION

Systems and methods described herein provide a computing node panel that interfaces with a traffic signal cabinet and a traffic signal controller. The computing node panel is installed into a traffic signal cabinet with a traffic signal controller and other hardware, in embodiments at an intersection of two roads, streets, or highways travelled by motor vehicles. The panel reads traffic control signals that enter the traffic signal cabinet from vehicle detection and pedestrian detection facilities; traffic signal display signals generated by the traffic signal controller; alarms associated with the operation the traffic signal facility including failure alarms, police control alarms, traffic signal cabinet door open alarms, and rail facility event alarms; and the status of equipment operating within the traffic signal cabinet such as battery back-up power equipment and traffic signal display equipment. Vehicle detection signals include those from inductive traffic signal loops, video detection or microwave equipment, or other fusion type detection systems that are used by the traffic signal controller to aid in the assignment of right-of-way at the intersection. Pedestrian detection signals include those generated from pedestrian push button controls or accessible pedestrian signal equipment. Traffic signal display signals include those leaving the traffic signal cabinet to provide displays for motorists and pedestrians including vehicle traffic signal displays, pedestrian traffic signal displays, bicycle traffic signal displays, emergency vehicle signal displays, transit displays, and dynamic traffic signal sign displays.

The panel digitizes the captured signal data and sends it wirelessly or via wired connection to a cloud-based platform provided herein. The platform analyzes the received data and may detect irregularities including evidence of malfunctioning equipment at the highway intersection or elsewhere. The panel also detects and reports when the cabinet door is open.

The platform may contact an operator of the traffic signal equipment, for example a municipal department of transportation or private contractor responsible for maintenance of the traffic signal equipment. The platform advises of potential signaling problems or malfunctioning equipment. The platform may make such contact via short message service (SMS) text, email, or other method. The platform receives data collected by the panel at the traffic signal intersection as well as global position system (GPS) data associated with tracked vehicles and other components.

The platform merely advises the municipality and maintenance contractors of actual and potential problems with signaling and data gathering hardware at a subject intersection. Neither the platform nor the panel causes the municipality to make any changes to the traffic signal cabinet, traffic signal controller or other auxiliary or peripheral devices within the traffic signal cabinet or elsewhere. Neither the panel, the platform, or any other component provided herein has any control over the actions of the traffic signal controller, or vehicle or pedestrian detection equipment.

Systems and methods of advanced traffic management also provide for advance detection notification and monitoring. Certain vehicles may receive priority under some conditions such that traffic signals may be preempted when a bus or emergency responder vehicle is approaching an intersection. If a signal were determined to be red, i.e. a stop signal, at the time the vehicle is expected to reach the signal, the traffic signal controller may cause the signal to instead become or remain green such that the vehicle may continue traveling through the subject intersection or otherwise through the signal. The decision to preempt the red signal and the action of doing so would be those of the municipality. The components provided herein would be limited to providing information.

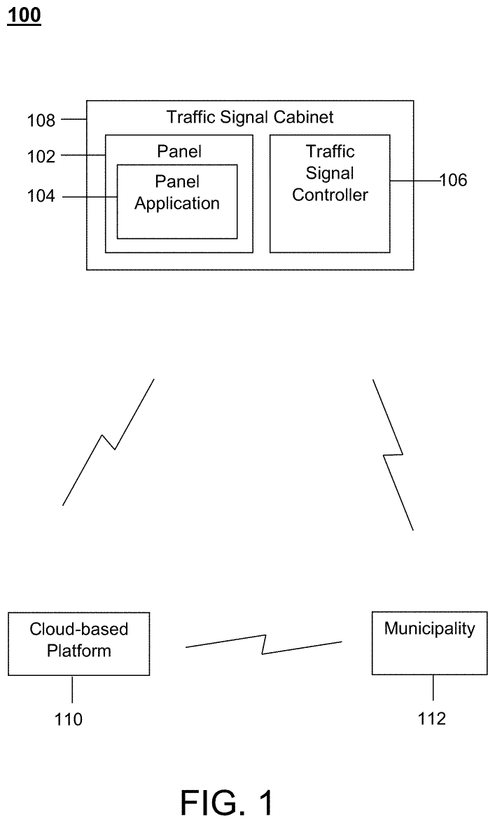

Turning to the figures, FIG. 1 is a block diagram of system of advanced traffic management according to an embodiment of the present disclosure. FIG. 1 depicts components and interactions of a system 100 provided herein.

System 100 comprises a computing node panel 102, a panel application 104, a traffic signal controller 106, a traffic signal cabinet 108, a platform 110, and a municipality 112. The computing node panel 102 may be referred to hereafter for brevity purposes as the panel 102. Similarly, the panel application 104, the traffic signal controller 106, and the traffic signal cabinet 108 may be referred to hereafter for brevity purposes as the application 104, the controller 106, and the cabinet 108, respectively.

The panel 102 comprises at least one hardware component that is installed inside or near the cabinet 108. The panel 102 communicates via at least one of wired and wireless connection with at least the cabinet 108, the controller 106 and the platform 110.

The application 104 executes at least partially on the panel 102. The application 104 scans the cabinet 108 and the controller 106 and gathers data about green, yellow, and red signals illuminated by the controller 106 and cabinet 108. The application 104 also scans for data about vehicle detection loops, pedestrian buttons, video detection data, active status alarms, and traffic signal control displays.

The application 104 digitizes the data it has captured such that it may be transmitted wirelessly or via wired connection to the platform 110 and processed there. Such digitization may convert the captured data into formats such that the data may be processed by server and network applications. The data may be transmitted wirelessly to server and network applications.

The platform 110 may be cloud-based and comprise at least a plurality of networked computers situated at one or more geographic locations. The platform 110 receives the digitized data from the panel 102 and performs various statistical and other operations on the data.

The platform 110 analyzes the data to detect problems in hardware or software associated with the controller 106, the cabinet 108, loops, pedestrian access devices, and detection equipment such as cameras. Loops, which are often submerged in pavement, may be accidentally cut during road maintenance operations or infrastructure improvements or may be damaged by ice and salt during winter months.

When analysis by the platform 110 suggests a potential malfunction or performance issue with any of these components, the platform 110 may contact the municipality 112 and provide advice of such situation. The municipality 112 may act on such advice as it sees fit, for example by dispatching a crew to the site to check on the controller 106 and other assets.

The municipality 112 may be a traffic or public works department of a city, town, county or other public body with responsibility for managing signaling and other traffic-related operations at intersections and elsewhere. In an embodiment, the municipality 112 may not be a public body and may instead be a private entity, for example a maintenance company operating or maintaining signaling facilities under contract with a public body. The term municipality 112 as used herein includes both public and non-public entities managing traffic-related assets.

The platform 110 also receives GPS information to assist in advance detection notification and monitoring for vehicles seeking passage. Vehicles such as buses may carry GPS tracking devices or trackers allowing their locations and therefore movement to be tracked. Tracking may be done by various third-party services unrelated to the municipality 112 or a party operating the panel 102 and platform 110.

When a bus, for example, is known to be a predetermined distance from a traffic signal, the third-party service may report the bus's location to the platform 110. The platform 110 may determine, based on data received from the panel 102, that the signal will be red or yellow at the time the bus is expected to reach the intersection protected by the signal. A policy may be in place to submit a request for the bus to “get a green” or receive passage when it reaches the intersection regardless of the signal's normally scheduled state at the time.

The platform 110, having received the GPS information about the bus's location and speed in some embodiments, may send a request to the municipality 112 to pre-empt the signal's scheduled state. The municipality 112, based on receiving the request and based on other information such as traffic flow at the intersection, weather, time of day, and day of the week, may cause the signal to be green when the bus reaches the intersection. In doing so, the municipality 112 causes the controller 106 to take this action without involvement by the panel 102. Hence, the bus may not be required to stop or even reduce its speed and may therefore pass unimpeded through the intersection.

The advanced detection notification and preemptive changing of signals described above may be provided for buses, police, fire, ambulances and other vehicles. It may in some embodiments be provided for bicycles and other micro-mobility vehicles such as scooters or mopeds.

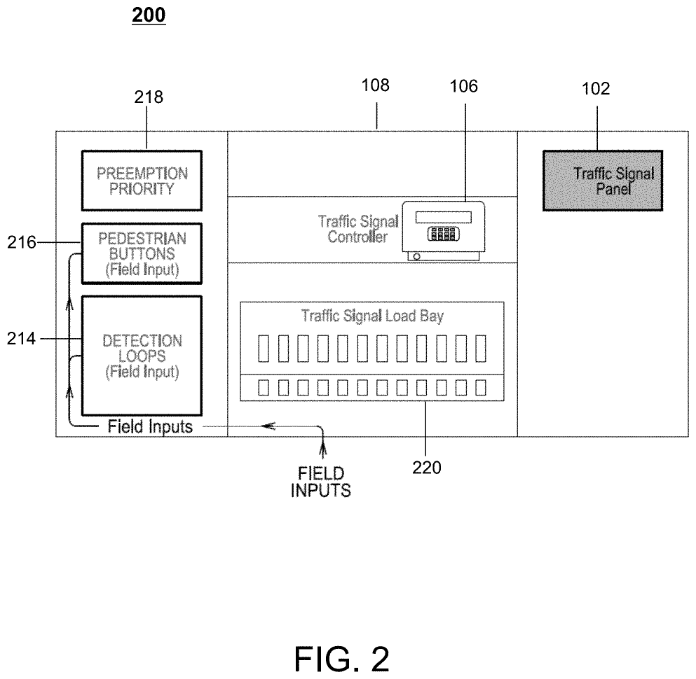

FIG. 2 through FIG. 7 are diagrams of components and process flows of systems and methods of advanced traffic management according to embodiments of the present disclosure. The components of FIG. 2 through FIG. 7 are indexed to FIG. 1 and system 100.

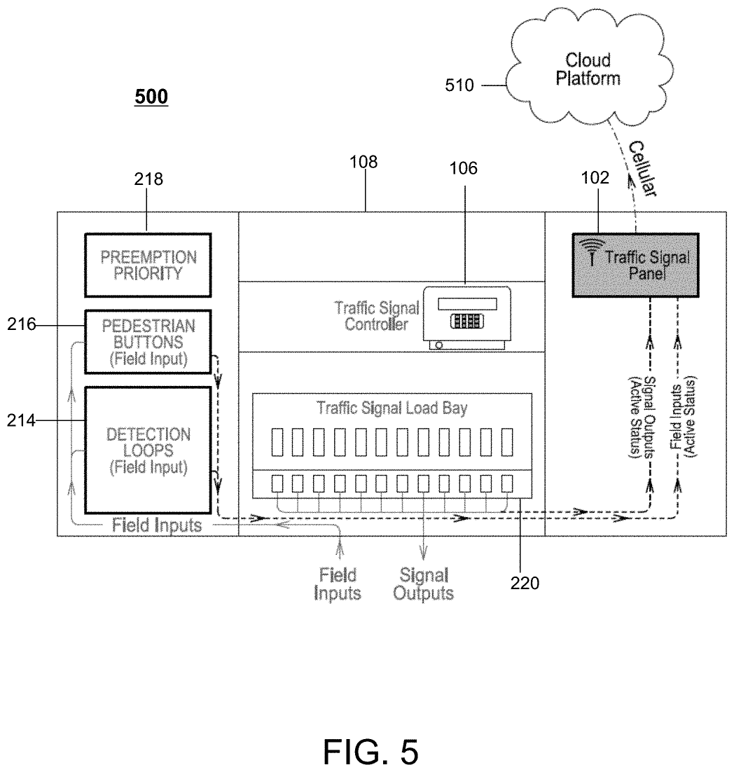

FIG. 2 through FIG. 7 depict the panel 102, the controller 106, and the cabinet 108 provided by the system 100. FIG. 5 through FIG. 7 depict cloud platform 510 which corresponds to the cloud-based platform 110 provided by the system 100.

FIG. 2 through FIG. 7 depict detection loops 214, pedestrian buttons 216, preemption priority 218, and traffic signal load bay 220. These components are provided by the municipality 112 and are installed in the cabinet 108 and elsewhere at an intersection or other locations, primarily near the intersection.

The detection loops 214 may be induction loops submerged in pavement that detect the presence and movement of vehicles. The pedestrian buttons 216 are accessed by pedestrians to request walk signals at intersections. Preemption priority 218 is functionality in the cabinet 108 and elsewhere to cause the controller 106 to change signaling for various reasons, for example for a vehicle that may be given a green signal when a red or yellow signal is normally scheduled. The traffic signal load bay 220 is functionality that controls signal outputs.

FIG. 2 through FIG. 7 depict the actions and process flows described herein. These include the panel 102 gathering data from the controller 106, furnishing the data to the platform 110, and the platform 110 replying to the panel 102 in some cases.

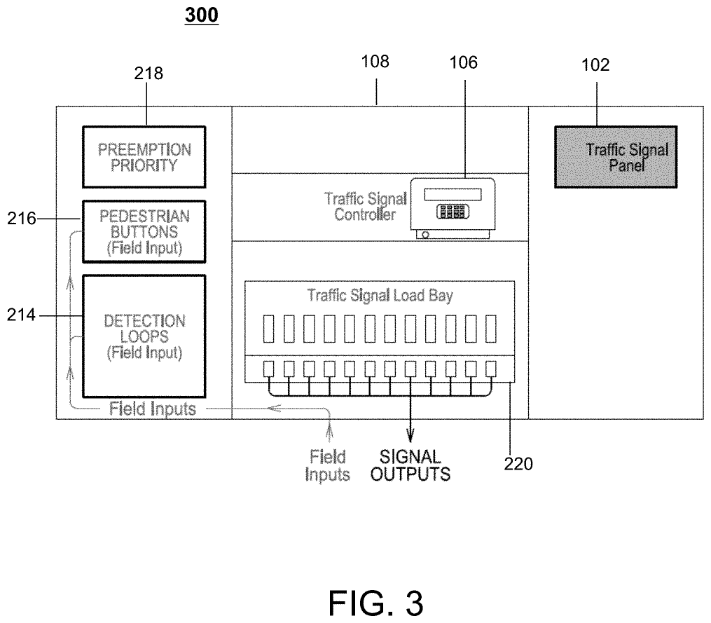

FIG. 2 shows field inputs by vehicles and pedestrians as vehicles pass over detection loops 214 and as pedestrians activate buttons 216 to request walk signals, respectively. FIG. 3 depicts the traffic signal load bay 220 displaying signal outputs, for example displaying traffic lights associated with vehicles passing over the detection loops 214 and the pedestrian activating the buttons 216. An example would be a “walk” signal being displayed resulting from a pedestrian activating a button 216 at a crosswalk.

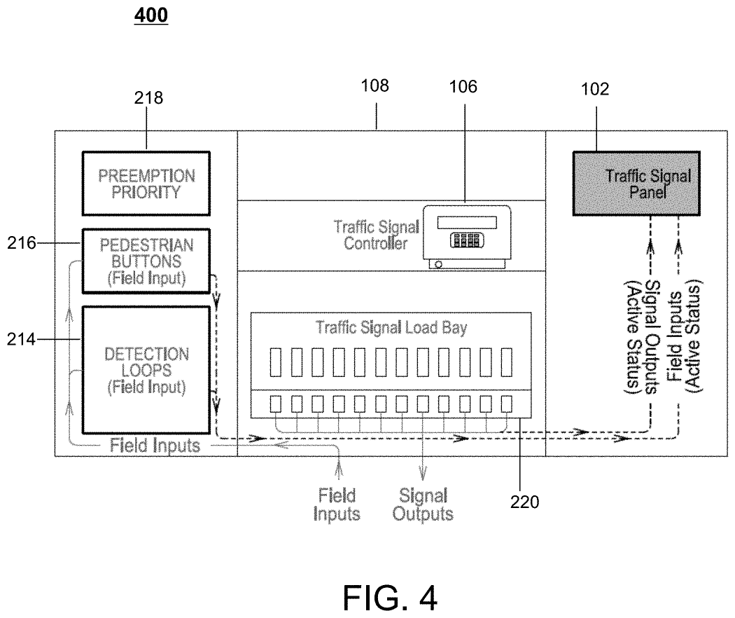

FIG. 4 depicts field inputs from pedestrian buttons 216 and detection loops 214 being captured by the panel 102. FIG. 4 also depicts signal outputs generated by the traffic signal load bay 220 being captured by the panel 102. FIG. 5 depicts the panel wirelessly sending the captured data to the cloud-based platform 510.

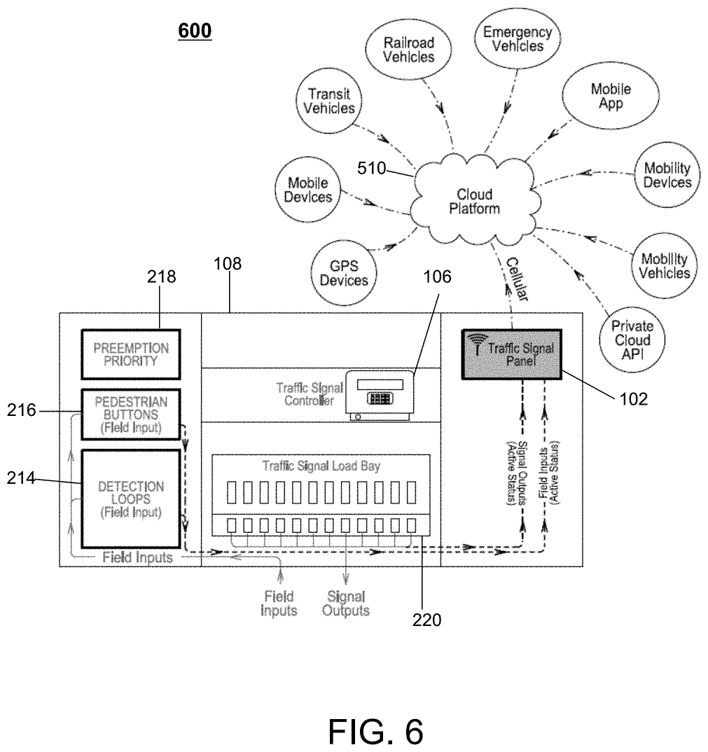

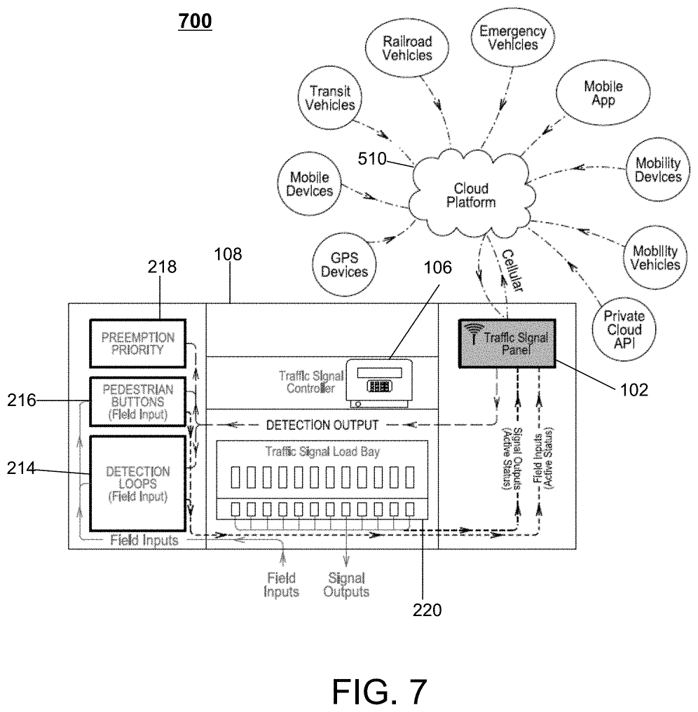

FIG. 6 depicts sources of data that may be received by the cloud platform 510 in addition to material sent to the cloud platform 510 by the panel 102. These additional sources include GPS devices, mobile devices, transit vehicles, railroad vehicles, and emergency vehicles. The additional sources further include mobile apps, mobility devices, mobility vehicles, and private cloud APIs. FIG. 7 is similar to FIG. 6 but also depicts electronic material moving from the cloud platform 510 to the panel 102.

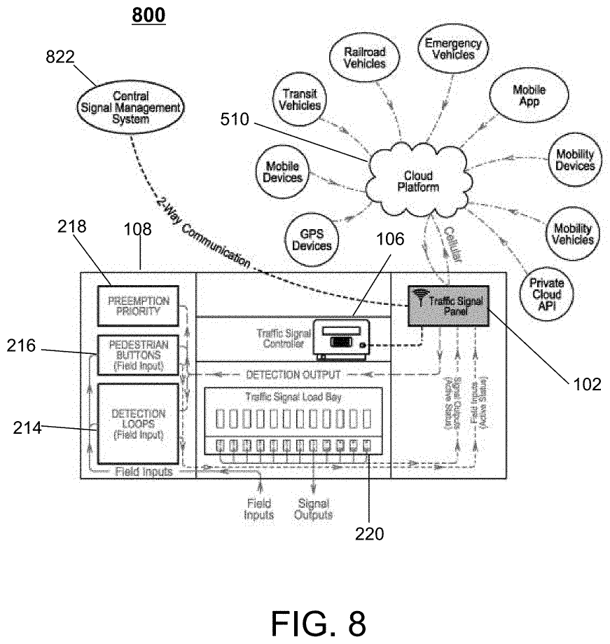

FIG. 8 is a diagram of components and process flows of systems and methods of advanced traffic management system according to an embodiment of the present disclosure. The traffic signal controller 106 communicates with a central traffic management 822 system through the traffic signal panel 102. This communication allows for remote adjustment in traffic signal controller program parameters and further allows for monitoring of the traffic signal controller 106.

While the system 500, the system 600, the system 700, and the system 800 shown in FIG. 5 through FIG. 8, respectively, depict cellular communication between the cloud platform 510 and the panel 102, technologies other than cellular may be used for such communication. For example, other wireless or wired communication technologies may be used for transmission between the cloud platform 510 and the panel 102.

Systems and methods also provide for certain pedestrians and others carrying mobile devices to request preemption priority to, for example, request a “walk” signal at a crosswalk. A person in a wheelchair may be unable to physically activate a pedestrian button to request a walk signal. The person may access an application or app provided herein on his/her mobile device and make such a request. The request may be received by at least one of the panel 102 and the platform 110 and forwarded on to the municipality 112. The municipality 112 receives the request and unilaterally decides whether to cause the controller 106 to display or sound the walk signal as requested.

Systems and methods further provide for monitoring railroad crossings and other railroad environments. The panel 102 may be modified where necessary to function with barrier operation, signaling and other controller hardware situated at or otherwise associated with railroad crossings where motor vehicles may pass. The panel 102 scans controller data and transmits the data via wired and/or wireless connection to the platform 110 that may in turn communicate with railroad personnel and regulatory agencies. When an accident occurs, the data gathered by the panel 102, which is recorded, may be helpful in reconstructing events leading up to the accident, the accident itself, and events taking place after the accident.

Systems and methods provide for time stamping the two minutes of traffic signal activity before a railroad event, during, and two minutes after to help with accident reconstruction. In embodiments, the time stamps may be applied at other time intervals before and after a railroad incident. Time stamping and other data associated with the incident is stored in files for use by agencies and other authorized parties.

Systems and methods may also provide for monitoring utility pump stations for pumping water captured by sewers and other facilities, particularly during periods of inclement weather. The panel 102 may be modified as necessary to monitor voltage levels of pumps moving large volumes of water. When voltage level of a pump is determined to have changed materially, the panel 102 may forward this scanned information to the platform 110 which may in turn forward this information to public works personnel. Such presence and operation of the panel 102, the platform 110, and associated hardware and software may be of value when a pump station is not manned and prompt detection of voltage level problems with pumps may alleviate or prevent flooding.

What is claimed is:

1. A method of facilitating advanced traffic management, comprising:
a panel installed in a traffic signal cabinet accessing the traffic signal cabinet and a traffic signal controller device in the cabinet;
the panel scanning data gathered by the cabinet and controller, the data comprising at least one of detection inputs and alarms processed by the controller;
the panel digitizing the scanned data for wireless transmission; and
the panel transmitting the digitized data to a cloud-based platform for analysis.

2. The method of claim 1, wherein the data gathered by the controller comprises active status data of traffic signals including data associated with vehicle detectors, pedestrian detectors, and associated equipment.

3. The method of claim 2, wherein active status data of traffic signals comprises at least one of red light, green light, yellow light, walk, and don't walk.

4. The method of claim 1, wherein detection inputs comprise at least one of inductive loops and pedestrian push buttons.

5. The method of claim 1, wherein analysis by the cloud-based platform comprises at least determinations of malfunctions of equipment associated with the controller.

6. The method of claim 5, wherein malfunctions comprise at least one of failures of video detection equipment, failures of inductive loops, and failures of pedestrian push buttons.

7. The method of claim 5, wherein the cloud-based platform communicates its determinations to an operator of the traffic signal controller and field traffic signal hardware.

8. The method of claim 1, wherein the panel reads inputs at about the same time the controller receives the inputs and reads outputs at about the same time controller assigns actions

9. A method of advanced detection notification for vehicles comprising
a computer receiving global positioning system (GPS) data regarding a present location of a vehicle
the computer receiving continuing wireless transmissions from a panel regarding status of at least one traffic signal presently in a path of the vehicle
the computer, based at least on analysis of the GPS data and analysis of the transmissions, determining a request for green is necessary for the vehicle to continue in motion when reaching the signal; and
the computer sending a request for green to an operator of a traffic controller associated with the traffic signal.

10. The method of claim 9, wherein the computer is a component in a cloud-based platform for facilitating advanced traffic management.

11. The method of claim 9, wherein the panel is installed in a traffic signal cabinet accessing a traffic signal controller device in the cabinet;

12. The method of claim 9, wherein the request for green is a request to the operator for the signal to allow passage of the vehicle when the vehicle reaches the signal

13. The method of claim 9, wherein the vehicle is one of a bus or other transit vehicle, a police vehicle, a fire vehicle, an ambulance, a bicycle, and micro-mobility vehicle such as a scooter or moped.

14. The method of claim 9, wherein the GPS data is generated by a GPS tracking device attached to the vehicle

15. The method of claim 9, wherein the determination that the request for green is necessary is further based on a predefined amount of distance between the signal and the vehicle.

16. A method of facilitating advanced traffic management, comprising:
a panel installed in a traffic signal cabinet receiving a wireless message, the traffic signal cabinet further housing a traffic signal controller;
the panel determining that the message was originated by a mobile device proximate the cabinet;
the panel determining that the message contains a request to activate a pedestrian movement control; and
the panel digitizing the request and sending the request to a cloud-based platform.

17. The method of claim 16, wherein the cloud-based platform analyzes the request and contacts an operator of the traffic signal controller with the request.

18. The method of claim 17, wherein the operator causes the traffic signal controller to honor the request.

19. The method of claim 18, wherein honoring the request comprises activating a “walk” signal to permit safe access at a pedestrian crosswalk.

20. The method of claim 19, wherein the mobile device is used by a handicapped person unable to access a pedestrian button at the crosswalk.
